(19) United States
(12) Patent Application Publication
(10) Pub. No.: US 2012/0183057 A1
(43) Pub. Date: Jul. 19, 2012

(54) SYSTEM, APPARATUS, AND METHOD FOR ENCODING AND DECODING DEPTH IMAGE

(75) Inventors: Byung Tae OH, Seoul (KR); Du Sik Park, Suwon-si (KR); Jae Joon Lee, Seoul (KR)

(73) Assignee: SAMSUNG ELECTRONICS CO., LTD., Suwon-si (KR)

(21) Appl. No.: 13/306,788

(22) Filed: Nov. 29, 2011

(30) Foreign Application Priority Data
Jan. 14, 2011 (KR) 10-2011-0003981

(51) Int. Cl. H04N 7/32

(52) U.S. Cl. 375/240.12; 375/E07.243

(57) ABSTRACT

An apparatus and method for encoding and decoding a depth image. An encoding apparatus may apply a block to a plurality of pixels forming a depth image, may divide the block into at least two areas based on a representative value, and may perform prediction encoding. Additionally, the encoding apparatus may encode prediction information associated with the block, may separate the at least two areas, and may select a prediction mode to perform prediction encoding.

### CROSS-REFERENCE TO RELATED APPLICATIONS

This application claims the priority benefit of Korean Patent Application No. 10-2011-0003981, filed on Jan. 14, 2011, in the Korean Intellectual Property Office, the disclosure of which is incorporated herein by reference.

### BACKGROUND

1. Field

Example embodiments of the following description relate to an apparatus and method for encoding and decoding a depth image, and more particularly, to an apparatus and method for encoding and decoding a depth image that may apply a block to the depth image and may divide the block into at least one area.

2. Description of the Related Art

Conventionally, a depth image is compressed as a single independent image, by applying an image compression process, such as an existing H.264/Moving Picture Experts Group (MPEG)-4 Advanced Video Coding (AVC) and the like, without a change. However, the depth image has significantly different properties from a color image.

For example, since the depth image includes piece-wise flat areas, a number of low-frequency components in the depth image is greater than that of the color image. Additionally, since an edge is formed between the piece-wise flat areas, intermediate-band frequency components are formed.

Due to the properties, it is difficult to expect a high compression efficiency using the image compression process such as the existing H.264/MPEG-4 AVC based on block quantization, and the like.

### SUMMARY

The foregoing and/or other aspects are achieved by providing an encoding apparatus including a block divider to apply a block to a plurality of pixels and to divide the block into at least one area, the plurality of pixels forming the depth image, and a block encoder to perform a prediction encoding on each of the at least one area.

The encoding apparatus may further include a prediction information encoder to encode prediction information of pixels, based on a result of the prediction encoding, the pixels being included in the block.

The encoding apparatus may further include a prediction mode selector to select a final prediction mode for the block.

The foregoing and/or other aspects are achieved by providing a decoding apparatus including a block divider to apply a block to a plurality of pixels and to divide the block into at least one area, the plurality of pixels forming the depth image, a prediction information decoder to decode prediction information associated with the block, and a block decoder to perform a prediction decoding on each of the at least one area, based on the prediction information.

The decoding apparatus may further include a prediction mode selector to select a final prediction mode for the block.

The foregoing and/or other aspects are achieved by providing an encoding method including applying a block to a plurality of pixels, and dividing the block into at least one area, the plurality of pixels forming the depth image, and performing a prediction encoding on each of the at least one area.

The encoding method may further include encoding prediction information of pixels, based on a result of the prediction encoding, the pixels being included in the block.

The encoding method may further include selecting a final prediction mode for the block.

The foregoing and/or other aspects are achieved by providing a decoding method including applying a block to a plurality of pixels, and dividing the block into at least one area, the plurality of pixels forming the depth image, decoding prediction information associated with the block, and performing a prediction decoding on each of the at least one area, based on the prediction information.

The decoding method may further include selecting a final prediction mode for the block.

The foregoing and/or other aspects are achieved by providing a system for processing depth images including an encoding apparatus to apply a block to a plurality of pixels, and to divide the block into at least one area, the plurality of pixels forming the depth image, wherein the encoding apparatus performs a prediction encoding on each of the at least one area; and a decoding apparatus to apply a second block to the plurality of pixels, and to divide the second block into at least one area, wherein the decoding apparatus decodes prediction information associated with the second block and performs prediction decoding on each of the at least one area of the second block, based on the prediction information, wherein the encoding apparatus transmits encoded prediction information to the decoding apparatus.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram to explain operations of an encoding apparatus and a decoding apparatus for a depth image according to example embodiments;

FIG. 2 illustrates a block diagram of a configuration of the encoding apparatus of FIG. 1;

FIG. 3 illustrates a block diagram of a configuration of the decoding apparatus of FIG. 1;

FIG. 4 illustrates a diagram of an example of dividing a block applied to a depth image into two areas according to example embodiments;

FIG. 5 illustrates a diagram of a definition of a pattern code of prediction information according to example embodiments;

FIGS. 6A through 6C illustrate diagrams of pattern codes of prediction information according to example embodiments;

FIG. 7 illustrates a diagram of an operation of encoding a pattern code of prediction information using differences according to example embodiments;

FIG. 8 illustrates a diagram of an operation of dividing prediction information according to example embodiments;

FIG. 9 illustrates a flowchart of a method of encoding a depth image according to example embodiments;

FIG. 10 illustrates a flowchart of an operation of selecting a prediction mode according to example embodiments; and

FIG. 11 illustrates a flowchart of a method of decoding a depth image according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

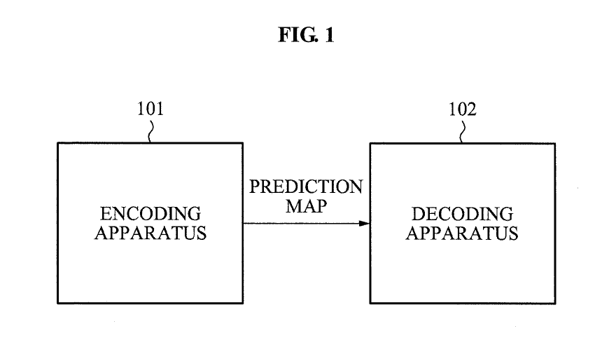

FIG. 1 illustrates a block diagram to explain operations of an encoding apparatus 101 and a decoding apparatus 102 for a depth image according to example embodiments.

The encoding apparatus 101 may apply a block with a size of “N×N” to a plurality of pixels that form a depth image. The encoding apparatus 101 may divide the applied block into at least one area, and may perform prediction encoding on each of the at least one area. Additionally, the encoding apparatus 101 may encode prediction information, namely prediction values of pixels included in the block, based on a result of the prediction encoding.

Such a mode is proposed by the example embodiments. The encoding apparatus 101 may select, as a final prediction mode, a mode with a greater encoding efficiency from among existing prediction modes and the proposed mode. The decoding apparatus 102 may perform the reverse operation to that of the encoding apparatus 101.

Thus, the encoding apparatus 101 may improve an intra-prediction coding process, and may enhance a compression efficiency of a depth image.

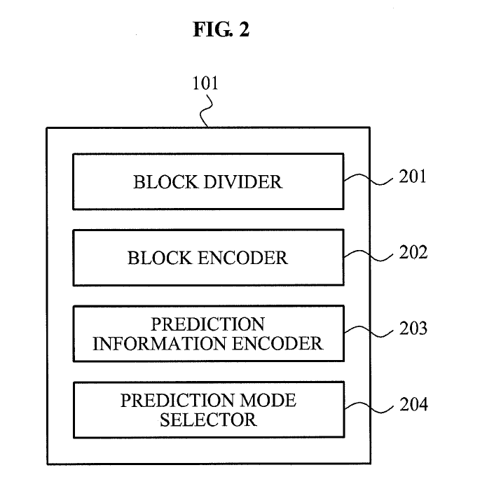

FIG. 2 illustrates a block diagram of a configuration of the encoding apparatus 101 of FIG. 1.

Referring to FIG. 2, the encoding apparatus 101 may include a block divider 201, a block encoder 202, and a prediction information encoder 203. Additionally, the encoding apparatus 101 may further include a prediction mode selector 204.

The block divider 201 may apply a block to a plurality of pixels that form a depth image, and may divide the block into at least one area. In this instance, the block may be divided based on a representative value k. In other words, the block may be divided into k areas.

For example, the block divider 201 may divide the block into the at least one area using neighboring pixels located around the block. Here, the neighboring pixels located around the block may be decoded in advance, and may be used to predict pixels included in the block.

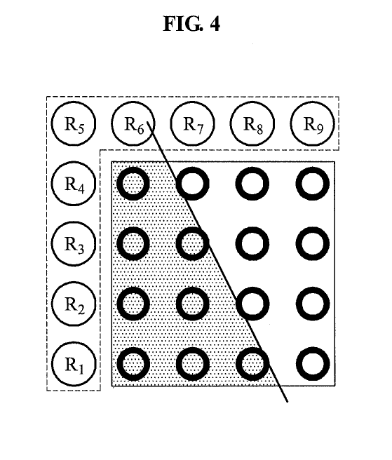

Specifically, the block divider 201 may classify the neighboring pixels based on a reference value of the neighboring pixels, and may divide the block into the at least one area based on the classified neighboring pixels. In this case, the block divider 201 may classify the neighboring pixels for each representative value, based on the reference value of the neighboring pixels. The reference value may be determined based on a mean value of the neighboring pixels, a median value of the neighboring pixels, a mean value of a maximum value and a minimum value of the neighboring pixels, and the like. An operation of dividing the block will be further described with reference to FIG. 4.

The block encoder 202 may perform prediction encoding on each of the at least one area of the block. Specifically, the block encoder 202 may quantize a residue, and may perform entropy encoding. Here, the residue may refer to a difference between an original pixel value and a prediction value of each of the pixels forming the at least one area. Additionally, the prediction value may be determined based on neighboring pixels related to the at least one area.

The prediction information encoder 203 may encode prediction information of the pixels included in the block, based on a result of the prediction encoding. In this instance, the prediction information may refer to a prediction value used to encode a pixel. The prediction information may need to be transmitted to the decoding apparatus 102 without a loss. In the example embodiments, the prediction information may correspond to a prediction map of FIG. 1.

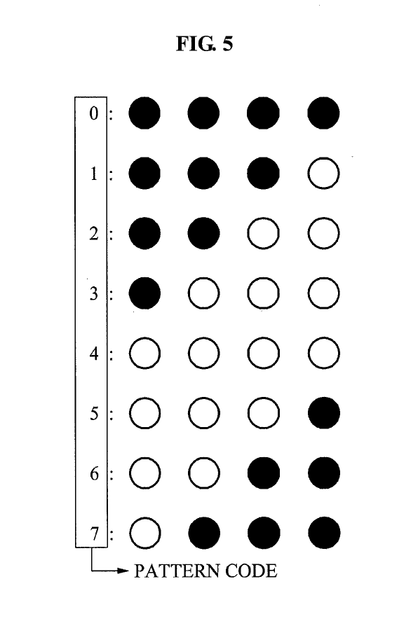

For example, the prediction information encoder 203 may encode the prediction information, based on a pattern code generated in one of a horizontal direction, a vertical direction, and a predetermined area of the block. Here, the prediction information encoder 203 may encode the prediction information based on a correlation between pattern codes of the prediction information. Additionally, the prediction information encoder 203 may encode the prediction information, based on a number of times encoding is performed using representative values of the neighboring pixels. An operation of encoding the prediction information will be further described with reference to FIGS. 5 through 8.

The prediction mode selector 204 may select a final prediction mode for the block.

Operations described in the example embodiments may indicate a new proposed mode that is different from intra-prediction modes defined in the H.264/Advanced Video Coding (AVC) standard. In this case, nine intra-prediction modes defined in the H.264/AVC standard may be provided, for example, a vertical mode, a horizontal mode, a Direct Current (DC) mode, a Diagonal-Down-Left (DDL) mode, a Diagonal-Down-Right (DDR) mode, a Vertical-Right (VR) mode, a Horizontal-Down (HD) mode, a Vertical-Left (VL) mode, and a Horizontal-Up (HU) mode. Accordingly, the prediction mode selector 204 may finally select either the new proposed mode or one of the intra-prediction modes defined in the H.264/AVC standard.

For example, the prediction mode selector 204 may separate the at least one area of the block based on a cost function for the result of the prediction encoding, and may select a prediction mode to perform prediction encoding on each of the at least one area. Additionally, the prediction mode selector 204 may select a mode with a lower cost function from among the new proposed mode and the intra-prediction modes defined in the H.264/AVC standard. Here, a cost function of the new proposed mode may need to be computed based on the prediction information.

The intra-prediction modes defined in the H.264/AVC standard may include a DC mode. The new proposed mode may be shared with the DC mode among the intra-prediction modes defined in the H.264/AVC standard. For example, the prediction mode selector 204 may determine a distinguishing level of a depth value of the block, based on the neighboring pixels, may separate the at least one area of the block using the distinguishing level, and may select a prediction mode to perform prediction encoding on each of the at least one area. When at least two depth values of a block may be distinguished, the prediction mode selector 204 may select the new proposed mode, instead of the DC mode. Here, the distinguishing level may be determined based on whether a difference between a maximum value and a minimum value of neighboring pixels exceeds a predetermined threshold.

As a result, the DC mode may be shared and thus, it is possible to maintain the nine intra-prediction modes defined in the H.264/AVC standard, thereby reducing additional flag bits generated when the new proposed mode is selected.

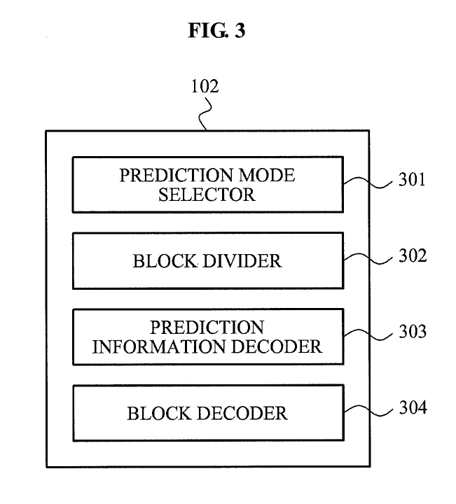

FIG. 3 illustrates a block diagram of a configuration of the decoding apparatus 102 of FIG. 1.

Referring to FIG. 3, the decoding apparatus 102 may include a block divider 302, a prediction information decoder 303, and a block decoder 304. Additionally, the decoding apparatus 102 may further include a prediction mode selector 301. The decoding apparatus 102 may perform the reverse operation to that of the above-described encoding apparatus 101.

The prediction mode selector 301 may select a prediction mode for prediction decoding of the block. Here, the prediction mode may be determined based on neighboring pixels located in neighboring blocks around the block being decoded.

The block divider 302 may apply the block to a plurality of pixels forming a depth image, and may divide the block into at least one area. For example, the block divider 302 may divide the block into the at least one area using neighboring pixels located around the block. Specifically, the block divider 302 may classify the neighboring pixels based on a reference value of the neighboring pixels, and may divide the block into the at least one area based on the classified neighboring pixels. Here, the block divider 302 may classify the neighboring pixels for each representative value, based on the reference value of the neighboring pixels.

The prediction information decoder 303 may decode prediction information associated with the block. For example, the prediction information decoder 303 may decode the prediction information, based on a pattern code generated in one of a horizontal direction, a vertical direction, and a predetermined area of the block. Here, the prediction information decoder 303 may decode the prediction information, based on a correlation between pattern codes of the prediction information. Additionally, the prediction information decoder 303 may decode the prediction information, based on a number of times decoding is performed using representative values of the neighboring pixels.

The block decoder 304 may perform prediction decoding on each of the at least one area of the block, based on the prediction information. Specifically, the block decoder 304 may extract prediction values of pixels included in the block from the decoded prediction information, may add the extracted prediction values and residues, and may determine pixel values of the pixels in the block.

FIG. 4 illustrates a diagram of an example of dividing a block applied to a depth image into two areas according to example embodiments.

The encoding apparatus 101 may apply a block to a plurality of pixels that form a depth image, and may divide the block into at least one area. Here, the encoding apparatus 101 may classify neighboring pixels located around the block, based on a reference value of the neighboring pixels, and may divide the block into the at least one area based on the classified neighboring pixels.

Referring to FIG. 4, neighboring pixels R₁ through R₉ may be located around a “4×4” block. In an example of an “N×N” block, neighboring pixels R₁ through R_{2N+}1 may exist. The encoding apparatus 101 may classify neighboring pixels into k types, based on the representative value k. Specifically, the encoding apparatus 101 may compute a reference value using the neighboring pixels, and may classify the neighboring pixels into k types based on the computed reference value. In the example embodiments, k may be equal to or greater than “2” (k≧2). When k is equal to “1,” a mode of the encoding apparatus 101 may be almost identical to the DC mode among the intra-prediction modes defined in the H.264/AVC standard.

The representative value k may be selected as a value used to efficiently encode a block, and may be separately transmitted to the decoding apparatus 102. For example, the representative value k may be determined variably for each frame, for each Group of Picture (GOP), or for each predetermined area.

As shown in FIG. 4, the neighboring pixels R₁ through R₉ may be classified into the pixels R₁ through R₆, and the pixels R₇ through R₉, since the representative value k is equal to “2.” Here, a reference value T may be computed, for example, as a mean value of neighboring pixels, a median value of the neighboring pixels, or a mean value of a maximum value and a minimum value of the neighboring pixels, as given in the following Equation 1:

$$T = \{ \begin{matrix}mean ( {R}_{1} , {R}_{2} , … {R}_{2 N + 1} ) \\ median ( {R}_{1} , {R}_{2} , … {R}_{2 N + 1} ) \\ mean ( MAX , MIN ) \\ …\end{matrix} \qquad [ Equation 1 ]$$

In other words, when the representative value k is equal to “2,” neighboring pixels may be classified into pixels with values greater than the reference value T, and pixels with values less than the reference value T.

Referring to FIG. 4, the encoding apparatus 101 may divide the block into the two areas, based on the classified neighboring pixels R₁ through R₉. Specifically, the encoding apparatus 101 may divide the block into the two areas, based on similarity between the neighboring pixels R₁ through R₉, and pixels included in the block.

Subsequently, to perform prediction encoding on the block, the encoding apparatus 101 may determine pixel values P₁ through Pₖ, by obtaining a mean value of neighboring pixels related to the two areas based on the representative value k. Accordingly, the encoding apparatus 101 may predict all pixels D₁ through D_{N×N} included in an “N×N” block, using a pixel value Pᵣ (1≦r≦k). Here, the encoding apparatus 101 may determine, as a prediction value of a pixel, the pixel value Pᵣ that is most similar to a pixel value of a pixel to be predicted.

FIG. 5 illustrates a diagram of a definition of a pattern code of prediction information according to example embodiments.

Specifically, FIG. 5 illustrates an operation of encoding prediction information, namely, a prediction value of each of the pixels included in a block. The prediction information may be losslessly encoded, and the encoded prediction information may be transmitted to the decoding apparatus 102. Here, the prediction information may indicate which prediction value is actually used to predict pixels D₁ through D_{N×N} so that prediction encoding may be performed.

To transmit the prediction information to the decoding apparatus 102, log₂(k) bits per pixel may be required. For example, an “N×N” block may require N² log₂(k) bits. However, when the N² log₂(k) bits may be required to transmit the prediction information, an encoding efficiency may be reduced rather than being increased. Accordingly, a process of reducing bits required to transmit prediction information will be proposed hereinafter.

For example, when N is equal to “1” and k is equal to “2,” log₂(2)bit per pixel may be required to encode and transmit prediction information. Accordingly, 16 bits may be required to transmit prediction information of a single block. The encoding apparatus 101 may define, in advance, a frequently occurring pattern using a piece-wise planner characteristic of a depth image, and may encode the prediction information.

As shown in FIG. 5, with respect to the prediction information of the “4×4” block, the encoding apparatus 101 may store, in a lookup table, patterns that may frequently occur based on a piece-wise planner characteristic, may code the stored patterns, and may transmit the coded patterns to the decoding apparatus 102. Since eight pattern codes are used as shown in FIG. 5, a number of finally transmitted bits may be reduced. In other words, the encoding apparatus 101 may encode prediction values in the “4×4” block based on the eight pattern codes of FIG. 5, and may transmit the encoded prediction values to the decoding apparatus 102.

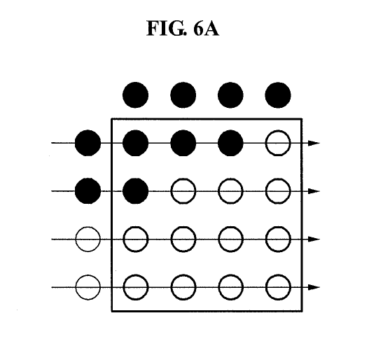

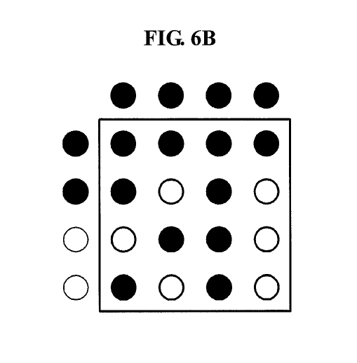

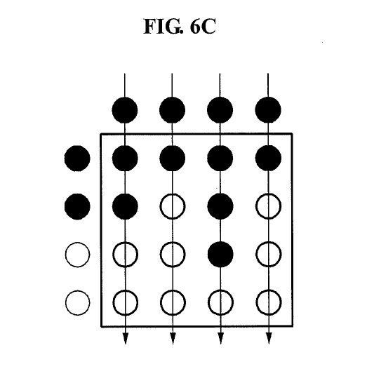

FIGS. 6A through 6C illustrate diagrams of pattern codes of prediction information according to example embodiments.

As shown in FIG. 6A, pattern codes may be generated in a horizontal direction. Additionally, as shown in FIG. 6C, pattern codes may be generated in a vertical directions. Furthermore, pattern codes may be generated in a predetermined area of a block. In this example, the encoding apparatus 101 may encode directions or predetermined areas where pattern codes are generated, together with prediction information.

However, when pattern codes are generated as shown in FIG. 6B, regardless of direction, the encoding apparatus 101 may encode the block using a prediction mode among the existing intra-prediction modes defined in the H.264/AVC standard, instead of using the proposed mode.

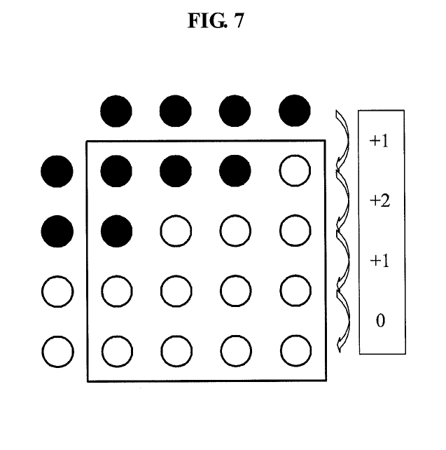

FIG. 7 illustrates a diagram of an operation of encoding a pattern code of prediction information using differences according to example embodiments.

The encoding apparatus 101 may encode each of the pattern codes of FIGS. 5 and 6, and may encode prediction information based on a correlation of the pattern codes. For example, the encoding apparatus 101 may encode the prediction information, using a difference value between pattern codes generated in either the horizontal direction, or the vertical direction.

As shown in FIG. 7, the encoding apparatus 101 may encode difference values per row between pattern codes generated in the horizontal direction. Referring to FIG. 5, a first pattern code of a block may be encoded using a difference value of “+1” between a pattern code 0 of neighboring pixels and a first pattern code 1. Additionally, a second pattern code of the block may be encoded using a difference value of “+2” between the first pattern code 1 and a second pattern code 3. Accordingly, the prediction information may be encoded using a difference value between pattern codes based on a correlation between the pattern codes, thereby improving the encoding efficiency for the prediction information. Here, the difference values may be encoded based on either Context-Adaptive Binary Arithmetic Coding (CABAC), or Context-Adaptive Variable-Length Coding (CAVLC). In other words, the encoded prediction information may be losslessly compressed, and may be transmitted to the decoding apparatus 102.

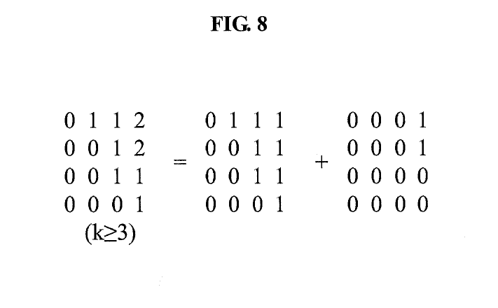

FIG. 8 illustrates a diagram of an operation of dividing prediction information according to example embodiments.

The example in which the representative value k is equal to “2” has been described above. FIG. 8 illustrates an example of encoding prediction information when the representative value k is equal to or greater than “3.” Referring to FIG. 8, prediction information with a representative value k of “3” may be divided into two pieces of prediction information with a representative value k of “2”. Specifically, the prediction information with the representative value k of “3” may be divided into prediction information where “0” and “1” are set to “0” and where “2” is set to be “1”, and prediction information where “0” is set to “0” and where “1” and “2” are set to “1”. In other words, prediction information with a representative value of “k” may be divided into “k−1” pieces of prediction information.

The encoding apparatus 101 may encode each of the “k−1” pieces of prediction information, in the above-described process. In other words, the encoding apparatus 101 may perform “k−1” times the operation of encoding the prediction information as described above.

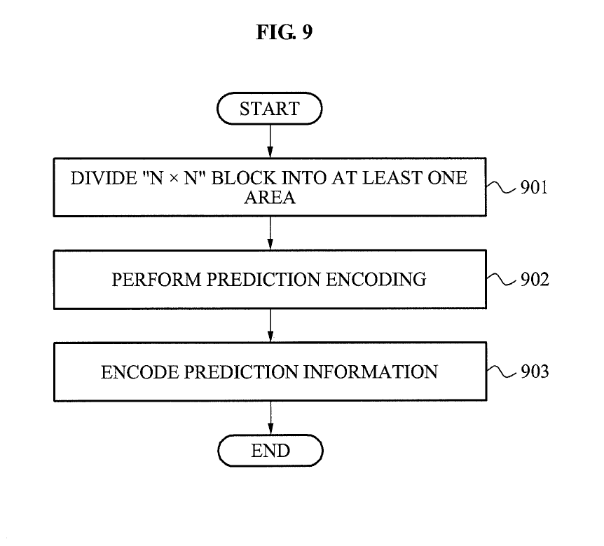

FIG. 9 illustrates a flowchart of a method of encoding a depth image according to example embodiments.

In operation 901, the encoding apparatus 101 may apply an “N×N” block to a plurality of pixels that form a depth image, and may divide the “N×N” block into at least one area. For example, the encoding apparatus 101 may divide a block into at least one area, using neighboring pixels located around the block. Specifically, the encoding apparatus 101 may classify the neighboring pixels based on a reference value of the neighboring pixels, and may divide the block into the at least one area based on the classified neighboring pixels. In this example, the encoding apparatus 101 may classify the neighboring pixels for each representative value, based on the reference value of the neighboring pixels.

In operation 902, the encoding apparatus 101 may perform prediction encoding on each of the at least one area.

In operation 903, the encoding apparatus 101 may encode prediction information of pixels included in the block, based on a result of the prediction encoding.

For example, the encoding apparatus 101 may encode the prediction information, based on a pattern code generated in one of a horizontal direction, a vertical direction, and a predetermined area of the block. Here, the encoding apparatus 101 may encode the prediction information based on a correlation between pattern codes of the prediction information. When the representative value is equal to or greater than “3,” the encoding apparatus 101 may encode the prediction information, based on a number of times encoding is performed using representative values of the neighboring pixels.

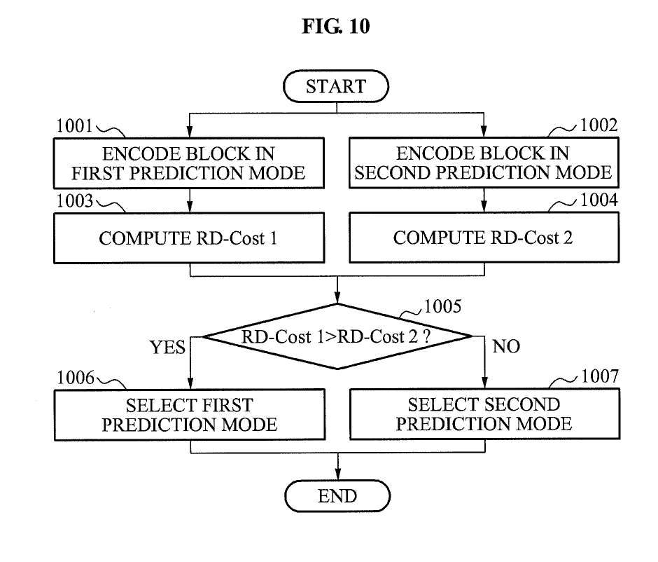

FIG. 10 illustrates a flowchart of an operation of selecting a prediction mode according to example embodiments.

In operation 1001, the encoding apparatus 101 may encode a block of a depth image in a first prediction mode. Here, the first prediction mode may be one of the nine intra-prediction modes defined in the H.264/AVC standard. As described above, the nine intra-prediction modes defined in the H.264/AVC standard may include, for example, a vertical mode, a horizontal mode, a DC mode, a DDL mode, a DDR mode, a VR mode, an HD mode, a VL mode, and an HU mode.

In operation 1002, the encoding apparatus 101 may encode the block of the depth image in a second prediction mode. Here, the second prediction mode may be a proposed mode according to the example embodiments, and may be used to divide the block into at least one area based on neighboring pixels located around the block.

In operation 1003, the encoding apparatus 101 may compute a cost function RD-Cost 1 for a result of prediction encoding performed in the first prediction mode. In operation 1004, the encoding apparatus 101 may compute a cost function RD-Cost 2 for a result of prediction encoding performed in the second prediction mode.

In operation 1005, the encoding apparatus 101 may compare the cost functions RD-Cost 1 and RD-Cost 2. Specifically, when the cost function RD-Cost 1 is greater than the cost function RD-Cost 2, the encoding apparatus 101 may select the first prediction mode as a final prediction mode in operation 1006. Conversely, when the cost function RD-Cost 1 is equal to or less than the cost function RD-Cost 2, the encoding apparatus 101 may select the second prediction mode as a final prediction mode in operation 1007.

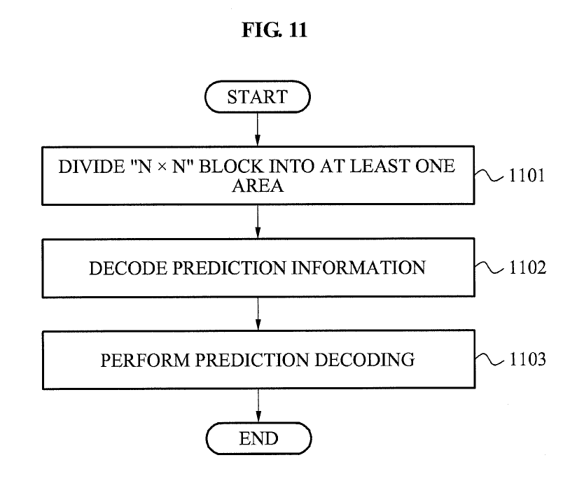

FIG. 11 illustrates a flowchart of a method of decoding a depth image according to example embodiments.

In operation 1101, the decoding apparatus 102 may apply an “N×N” block to a plurality of pixels that form a depth image, and may divide the “N×N” block into at least one area. For example, the decoding apparatus 102 may divide a block into at least one area, using neighboring pixels located around the block. Specifically, the decoding apparatus 102 may classify the neighboring pixels based on a reference value of the neighboring pixels, and may divide the block into the at least one area based on the classified neighboring pixels. In this example, the decoding apparatus 102 may classify the neighboring pixels for each representative value, based on the reference value of the neighboring pixels.

In operation 1102, the decoding apparatus 102 may decode prediction information associated with the block.

For example, the decoding apparatus 102 may decode the prediction information, based on a pattern code generated in one of a horizontal direction, a vertical direction, and a predetermined area of the block. Here, the decoding apparatus 102 may decode the prediction information based on a correlation between pattern codes of the prediction information. When the representative value is equal to or greater than “3,” the decoding apparatus 102 may decode the prediction information, based on a number of times decoding is performed using representative values of the neighboring pixels.

In operation 1103, the decoding apparatus 102 may perform prediction decoding on each of the at least one area. Specifically, the decoding apparatus 102 may add a residue to a prediction value of each of the pixels in the block, based on the prediction information, and may determine a final pixel value of each of the pixels.

Other descriptions of FIGS. 9 and 11 have been already given above with reference to FIGS. 1 through 8.

According to example embodiments, prediction encoding may be performed on pixels exhibiting similar characteristics in a block based on characteristics of a depth image, and thus, it is possible to improve prediction accuracy.

Additionally, according to example embodiments, prediction information based on a prediction encoding result may be encoded using a frequently occurring pattern, and thus, it is possible to increase an encoding efficiency for the prediction information.

Furthermore, according to example embodiments, prediction information may be encoded based on a correlation between pattern codes of the prediction information, and thus, it is possible to increase an encoding efficiency for the prediction information.

Moreover, according to example embodiments, different compression processes may be applied for each block by selecting a more efficient mode from among a proposed mode and existing prediction modes, and thus, it is possible to improve compression efficiency.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

Moreover, the encoding apparatus 101 and the decoding apparatus 102, as shown in FIG. 1, may each include at least one processor to execute at least one of the above-described methods.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An encoding apparatus for encoding a depth image, the encoding apparatus comprising:
a block divider to apply a block to a plurality of pixels, and to divide the block into at least one area, the plurality of pixels forming the depth image; and
a block encoder to perform a prediction encoding on each of the at least one area.

2. The encoding apparatus of claim 1, wherein the block divider divides the block into the at least one area, using neighboring pixels located around the block.

3. The encoding apparatus of claim 2, wherein the block divider classifies the neighboring pixels based on a reference value of the neighboring pixels, and divides the block into the at least one area based on the classified neighboring pixels.

4. The encoding apparatus of claim 3, wherein the reference values are determined based on a mean value of the neighboring pixels, a median value of the neighboring pixels, or a mean value of maximum and minimum values of the neighboring pixels.

5. The encoding apparatus of claim 3, wherein the block divider classifies the neighboring pixels for each representative value, based on the reference value of the neighboring pixels.

6. The encoding apparatus of claim 1, further comprising:
a prediction information encoder to encode prediction information of pixels, based on a result of the prediction encoding, the pixels being included in the block.

7. The encoding apparatus of claim 6, wherein the prediction information encoder encodes the prediction information, based on a pattern code generated in one of a horizontal direction, a vertical direction, and a predetermined area of the block.

8. The encoding apparatus of claim 7, wherein the prediction information encoder encodes the prediction information, based on a correlation between pattern codes of the prediction information.

9. The encoding apparatus of claim 6, wherein the prediction information encoder encodes the prediction information, based on a number of times encoding is performed using representative values of the neighboring pixels.

10. The encoding apparatus of claim 1, further comprising:
a prediction mode selector to select a final prediction mode for the block.

11. The encoding apparatus of claim 10, wherein the prediction mode selector separates the at least one area of the block based on a cost function for the result of the prediction encoding, and selects a prediction mode to perform prediction encoding on each of the separated at least one area.

12. The encoding apparatus of claim 10, wherein the prediction mode selector determines a distinguishing level of a depth value of the block, based on the neighboring pixels, separates the at least one area of the block using the distinguishing level, and selects a prediction mode to perform prediction encoding on each of the separated at least one area.

13. The encoding apparatus of claim 12, wherein the distinguishing level is determined based on whether a difference between a maximum value and a minimum value of neighboring pixels exceeds a predetermined threshold.

14. A decoding apparatus for decoding a depth image, the decoding apparatus comprising:
a block divider to apply a block to a plurality of pixels, and to divide the block into at least one area, the plurality of pixels forming the depth image;
a prediction information decoder to decode prediction information associated with the block; and
a block decoder to perform a prediction decoding on each of the at least one area, based on the prediction information.

15. The decoding apparatus of claim 14, wherein the block divider divides the block into the at least one area, using neighboring pixels located around the block.

16. The decoding apparatus of claim 15, wherein the block divider classifies the neighboring pixels based on a reference value of the neighboring pixels, and divides the block into the at least one area based on the classified neighboring pixels.

17. The decoding apparatus of claim 16, wherein the block divider classifies the neighboring pixels for each representative value, based on the reference value of the neighboring pixels.

18. The decoding apparatus of claim 14, wherein the prediction information decoder decodes the prediction information, based on a pattern code generated in one of a horizontal direction, a vertical direction, and a predetermined area of the block.

19. The decoding apparatus of claim 18, wherein the prediction information decoder decodes the prediction information, based on a correlation between pattern codes of the prediction information.

20. The decoding apparatus of claim 18, wherein the prediction information decoder decodes the prediction information, based on a number of times decoding is performed using representative values of the neighboring pixels.

21. The decoding apparatus of claim 14, further comprising:
a prediction mode selector to select a final prediction mode for the block.

22. The decoding apparatus of claim 21, wherein the prediction mode selector determines a distinguishing level of a depth value of the block, based on the neighboring pixels, separates the at least one area of the block using the distinguishing level, and selects a prediction mode to perform prediction decoding on each of the separated at least one area.

23. The decoding apparatus of claim 14, wherein the block decoder extracts prediction values of pixels included in the block from the decoded prediction information, adds the extracted prediction values and residues, and determines pixel values of the pixels in the block.

24. The decoding apparatus of claim 23, wherein the decoding apparatus adds residue to a prediction value of each of the pixels of the block, based on the prediction information, and determines a final pixel value of each of the pixels.

25. A method of encoding a depth image, the method comprising:
applying, using an encoding apparatus, a block to a plurality of pixels, and dividing the block into at least one area, the plurality of pixels forming the depth image; and
performing, using an encoding apparatus, a prediction encoding on each of the at least one area.

26. The method of claim 25, wherein the applying comprises dividing the block into the at least one area, using neighboring pixels located around the block.

27. The method of claim 26, wherein the applying comprises classifying the neighboring pixels based on a reference value of the neighboring pixels, and dividing the block into the at least one area based on the classified neighboring pixels.

28. The method of claim 27, wherein the reference value is determined based on a mean value of the neighboring pixels, a median value of the neighboring pixels, or a mean value of maximum and minimum values of the neighboring pixels.

29. The method of claim 27, wherein the applying comprises classifying the neighboring pixels for each representative value, based on the reference value of the neighboring pixels.

30. The method of claim 25, further comprising:
encoding prediction information of pixels, based on a result of the prediction encoding, the pixels being included in the block.

31. The method of claim 30, wherein the encoding comprises encoding the prediction information, based on a pattern code generated in one of a horizontal direction, a vertical direction, and a predetermined area of the block.

32. The method of claim 31, wherein the encoding comprises encoding the prediction information, based on a correlation between pattern codes of the prediction information.

33. The method of claim 30, wherein the encoding comprises encoding the prediction information, based on a number of times encoding is performed using representative values of the neighboring pixels.

34. The method of claim 25, further comprising:
selecting a final prediction mode for the block.

35. The method of claim 34, wherein the selecting comprises separating the at least one area of the block based on a cost function for the result of the prediction encoding, and selecting a prediction mode to perform prediction encoding on each of the separated at least one area.

36. The method of claim 34, wherein the selecting comprises determining a distinguishing level of a depth value of the block, based on the neighboring pixels, separating the at least one area of the block using the distinguishing level, and selecting a prediction mode to perform prediction encoding on each of the separated at least one area.

37. The method of claim 36, wherein the distinguishing level is determined based on whether a difference between a maximum value and a minimum value of neighboring pixels exceeds a predetermined threshold.

38. A method of decoding a depth image, the method comprising:
applying, using a decoding apparatus, a block to a plurality of pixels, and dividing the block into at least one area, the plurality of pixels forming the depth image;
decoding, using a decoding apparatus, prediction information associated with the block; and
performing, using a decoding apparatus, a prediction decoding on each of the at least one area, based on the prediction information.

39. The method of claim 38, wherein the applying comprises dividing the block into the at least one area, using neighboring pixels located around the block.

40. The method of claim 39, wherein the applying comprises classifying the neighboring pixels based on a reference value of the neighboring pixels, and dividing the block into the at least one area based on the classified neighboring pixels.

41. The method of claim 40, wherein the applying comprises classifying the neighboring pixels for each representative value, based on the reference value of the neighboring pixels.

42. The method of claim 38, wherein the decoding comprises decoding the prediction information, based on a pattern code generated in one of a horizontal direction, a vertical direction, and a predetermined area of the block.

43. The method of claim 42, wherein the decoding comprises decoding the prediction information, based on a correlation between pattern codes of the prediction information.

44. The method of claim 43, wherein the decoding comprises decoding the prediction information, based on a number of times decoding is performed using representative values of the neighboring pixels.

45. The method of claim 38, further comprising:
selecting a final prediction mode for the block.

46. The method of claim 45, wherein the selecting comprises determining a distinguishing level of a depth value of the block, based on the neighboring pixels, separating the at least one area of the block using the distinguishing level, and selecting a prediction mode to perform prediction decoding on each of the separated at least one area.

47. The method of claim 38, further comprising extracting prediction values of pixels included in the block from the decoded prediction information, adding the extracted prediction values and residues, and determining pixel values of the pixels in the block.

48. The decoding apparatus of claim 47, further comprising adding residue to a prediction value of each of the pixels of the block, based on the prediction information, and determining a final pixel value of each of the pixels.

49. A non-transitory computer readable recording medium storing a program to cause a computer to implement the method of claim 25.

50. A system for processing a depth image, the system comprising:
an encoding apparatus to apply a block to a plurality of pixels, and to divide the block into at least one area, the plurality of pixels forming the depth image,
wherein the encoding apparatus performs a prediction encoding on each of the at least one area; and
a decoding apparatus to apply a second block to the plurality of pixels, and to divide the second block into at least one area,
wherein the decoding apparatus decodes prediction information associated with the second block and performs prediction decoding on each of the at least one area of the second block, based on the prediction information,
wherein the encoding apparatus transmits encoded prediction information to the decoding apparatus.
